(19) United States
(12) Patent Application Publication
(10) Pub. No.: US 2003/0028711 A1
(43) Pub. Date: Feb. 6, 2003

(54) Monitoring in-use memory areas for power conservation

(76) Inventors: Steven C. Woo, Saratoga, CA (US); Pradeep Batra, Santa Clara, CA (US)

Correspondence Address: LEE & HAYES, PLLC, 421 W. RIVERSIDE AVE, STE 500, SPOKANE, WA, 99201, US

(21) Appl. No.: 09/919,361

(22) Filed: Jul. 30, 2001

(51) Int. Cl. G06F 12/00

(52) U.S. Cl. 711/106

(57) ABSTRACT

Described herein is a system for operating memory at reduced power, based on whether the memory is actually in use. A memory controller receives notifications from an operating system or other computer program regarding which areas of physical memory are actually in use. The memory controller is responsive to the notifications to operate unused portions of memory at reduced power. In systems having refreshable memory, the memory controller omits refreshing for those memory rows that are not currently in use.

### TECHNICAL FIELD

This invention relates to memory devices and systems and power conservation in such devices and systems.

### BACKGROUND

Dynamically refreshed memory, usually referred to as dynamic random access memory or DRAM, is a type of memory device found in many different computing devices. A typical DRAM device may have millions, billions or even more DRAM memory cells. A DRAM memory cell is commonly formed by a single transistor and an associated capacitance. The capacitance is charged to a voltage that indicates a bit value of either “0” or “1”. The capacitance loses its charge rather quickly, bringing about the need for periodic refreshing.

In many computer systems, the power consumption of DRAM memory is insignificant compared to other system components such as hard disks, high-performance microprocessors, active matrix displays, CRTs, etc. However, in other computer systems, such as the newly emerging and evolving class of mobile devices known as “handhelds” or “PDAs” (“personal digital assistants”), the power consumption of the DRAM memory is significant as compared to other components in the computer system. In comparison to many of the more traditional types of computers, such as desktop or personal computers, many mobile computing devices, are smaller, less capable, and use components that consume less power. For example, many of these systems have small, monochromic displays, low performance CPUs, and no hard disks. Some of these mobile systems, furthermore, rely on batteries for their operating power. As a result of these factors, power consumption of memory subsystems has become more of an issue in these devices; there is a strong need to reduce memory power consumption and to thereby extend the time between required battery replacement or recharging.

Memory devices with power management features are becoming available to address this need. For example, DRAMs are available that support various different reduced power modes. However, power savings come at the cost of performance. Typically, a greater penalty in access speed is imposed at each increasing degree of power savings.

### BRIEF DESCRIPTION OF THE DRAWINGS

FIG. 1 is a block diagram of a memory system that incorporates aspects of the present invention.

FIG. 2 is a block diagram showing pertinent parts of a memory controller and memory device of the present invention.

FIG. 3 is a flowchart showing actions performed to refresh a memory row in accordance with the present invention.

FIGS. 4-6 are block diagrams showing pertinent parts of a memory controller and memory device in alternative embodiments of the present invention.

FIG. 7 is a flowchart showing actions performed in the embodiment of FIG. 6 to refresh a memory row in accordance with the present invention.

FIG. 8 is a block diagram showing pertinent parts of a memory controller and memory device in another embodiment of the present invention.

### DETAILED DESCRIPTION

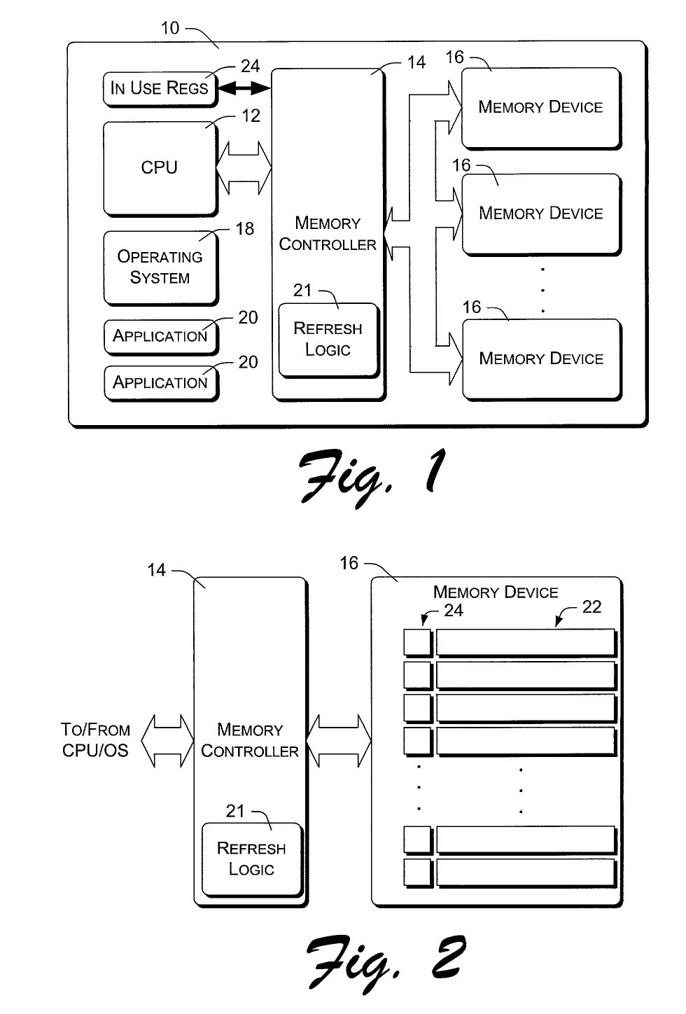

FIG. 1 shows pertinent portions of a computer system 10, including a CPU 12, a memory controller 14, and memory devices 16. Although the memory controller and memory devices are shown to be separate entities in this figure, the same techniques apply for memory controllers that are integrated into the CPU, as well as memory that is integrated with either the controller and/or the CPU.

The computer system also includes an operating system 18 and one or more applications or application programs 20. The operating system and applications are typically initially stored on some form of non-volatile memory (not shown). They are subsequently loaded into executable memory and executed by CPU 12. Devices 16 form at least part of the executable memory. In many cases, the computer system implements a virtual memory system, so that only portions of the operating system and applications are actually present in physical memory at any given time.

The architecture of FIG. 1 is typical of many computers and computer-like devices, and is not limited to conventional desktop systems or even to conventional portable computer systems. Many types of devices, such as entertainment and game devices, industrial control devices, and others either use an architecture such as this or can be easily adapted to use such an architecture.

The operating system is typically an off-the-shelf, general-purpose operating system that provides low-level management functions and support for higher-level application programs. However, the operating system might alternatively be a custom application or program designed for a particular, specialized purpose, and might itself perform the specialized functions that would in other cases be performed by separate application programs.

In the described embodiment, memory devices 16 have dynamically refreshable memory cells. Such devices are typically referred to as DRAMs (dynamic random access memory), or DRAM devices. Other types of memory devices can, however, also benefit from the techniques described herein.

Memory controller 14 acts as an interface between CPU 12 and the memory devices. Memory controller 14 has refresh logic 21 that is configured to periodically refresh the memory cells of the memory devices.

FIG. 2 shows memory controller 14 and one of memory devices 16 in more detail. Each of memory devices 16 has multiple dynamically refreshable memory cells, arranged in rows 22. In operation, memory controller 14 can receive memory instructions from various sources, including but not limited to, operating system 18, CPU 12, a graphics adapter (not shown), and/or other sources. Memory controller 14 responds to the instructions by performing various memory operations such as, for example, reads and writes.

Although not shown, memory device 16 also has a plurality of sense amplifiers. The sense amplifiers are typically arranged in one or more rows. In many systems, one row of sense amplifiers is associated with a plurality, or bank, or memory cells. A read operation typically involves reading an entire row of memory cells into an associated row of sense amplifiers. This initial operation is sometimes referred to as a “Row Address Strobe”, or “RAS”, operation, although more accurately it is referred to as a “sense” or “activate” operation. It is also possible for the “sense” operation to read less than, or even more than, one entire row of bits to the plurality of sense amplifiers. Following the “sense” operation, one or more of the sense amplifiers are read by memory controller 14.

The RAS or “sense” operation is destructive—the transfer of data from the memory cells to the sense amplifiers destroys the data held by the memory cells. Accordingly, data in the sense amplifiers are written back to the memory cells after the sense operation.

A write operation is similar, in that row data is initially read to the sense amplifiers in a sense operation. After the initial sense operation, an operation sometimes referred to as a “Column Address strobe” or “CAS” operation is performed to write new data to at least some of the sense amplifiers and to the corresponding memory cells.

In order to ensure that data in each of the memory cells remains accurate, the data in the memory cells is periodically refreshed in a refresh operation. A refresh operation typically comprises reading a row to the sense amplifiers and then writing the same data back to the row. Memory controller 14 is typically configured to perform periodic refresh cycles on its own, without receiving instructions from the CPU; generally, the CPU is unaware of refresh cycles. In many prior art systems, a refresh operation is performed on every memory cell in every memory row of a memory device at least once during each refresh period. The refresh period has a duration equal to a parameter often referred to as “TREF”, and the refresh period is often referred to as the TREF period.

The embodiments described herein include circuits and logic for keeping track of which memory cells or memory areas are actually in use. When the memory is dynamically refreshable memory such as DRAM, a reduction in power consumption can be implemented by omitting or skipping refreshing of unused cells or areas. An added benefit is that refresh operations can be limited to only those memory cells that are storing useful data. By reducing the number of useless refresh operations being performed (which can delay subsequent requests from requesters such as the CPU), the memory system is more available for memory requests, increasing performance by reducing latency and increasing bandwidth. Thus, the present embodiment includes circuits and logic for keeping track of which memory rows are actually in use and therefore need refreshing. Disclosed embodiments also include circuits and logic for periodically refreshing those memory rows that are in use, and for omitting refreshing of memory rows that are not in use. Omitting refreshing of identified, non-used areas of memory can provide significant power savings as well as increases in performance.

More specifically, the described embodiments include one or more dynamically changeable use registers 24. Such use registers are shown in FIG. 1 as being implemented apart from either the memory controller or the memory devices. In preferred embodiments shown by FIGS. 2 and 4, however, the use registers are implemented as part of the memory devices 16 or as part of memory controller 14.

In the embodiment of FIG. 2, each memory device includes one or more dynamically changeable use registers 24. These registers indicate used and unused memory cells or groups of memory cells. More specifically, use registers 24 in this embodiment comprise individual bits or flags that are associated respectively with individual memory cell rows. Each bit or flag is set to indicate whether the corresponding row is actually in use, and whether it therefore needs to be refreshed. The term “in use” means merely that the data stored by the “in use” memory is intended to remain valid and non-volatile. The determination of whether a memory area is “in use” is made by memory controller 14, CPU 12, operating system 18, or applications 20, as will be described in more detail below.

Use registers 24 allow power-saving measures to be taken with respect to areas of memory that are not being used. In the illustrated case of DRAM memory, the use registers allow refreshing of unused memory rows to be omitted. Alternative types of power reduction measures might be available depending on the particular type of memory device being utilized. For example, it might be possible in some types of memory to operate unused memory cells in high-latency modes that consume less power than normal, low-latency modes.

In the described embodiment, refresh logic 21 of memory controller 14 determines whether individual memory rows are in use, and sets or programs use registers 24 accordingly. In a very simple embodiment, the memory controller initially sets use registers 24 to indicate that all rows are unused. Then, as instructions are received to access various portions of memory, the use registers corresponding to those portions of memory are set or programmed to indicate that those portions are now being used. Alternatively, the DRAMs themselves might set the use registers in some embodiments.

More preferably, operating system 18 is configured to notify memory controller 14 regarding used and unused memory. Typically, an operating system includes facilities for dynamically allocating and de-allocating memory. When loading an application, for example, an operating system typically designates specific areas of memory for the code of the application and specific areas of memory for use by the program in storing data. Allocation and de-allocation typically involve maintaining one or more tables or other data structures indicating those areas of memory that have been designated for use in this manner. Such areas are typically identified within such tables or data structures by their physical memory addresses. Memory allocation can also take place as a result of an application program requesting the use of additional memory during actual execution of the application program. In response to requests such as this, the operating system designates areas of physical memory for exclusive use by the requesting application programs.

In accordance with this embodiment of the invention, the operating system is configured to notify memory controller 14 in response to memory allocations such as those described above. In addition, the operating system is configured to notify memory controller 14 in response to memory de-allocations. Allocated memory is deemed to be in-use, and de-allocated memory (or any memory that has not yet been allocated) is deemed not to be in-use.

Memory devices 16 are often referred to collectively as “physical” or “primary” memory. Physical memory is characterized by being randomly accessible through the specification of physical memory addresses: CPU 12 accesses memory devices 16 by specifying physical memory addresses to memory controller 14. The available range physical memory addresses is often referred to as a physical address space. Because the amount of physical memory is finite, the physical address space is also finite and in some cases is relatively small compared to the needs of operating system 18 and application programs 20.

In order to provide a larger effective address space, many operating systems implement “virtual” memory. In a virtual memory system, each application program has available its own relatively large virtual address space. Each such virtual address space is typically larger than the physical address space.

In systems such as this, the operating system typically allocates virtual memory to requesting application programs. When such virtual memory is allocated, the operating system creates a translation entry or “mapping” between an allocated range of virtual memory addresses and a corresponding range of physical memory addresses. Each translation entry or mapping translates from a virtual or source address to a physical or target address. The operating system maintains a translation or mapping table that contains all current translations or mappings.

When an application program subsequently references a virtual memory address, the operating system and CPU use the translation table to translate from the virtual address to the physical address, and the actual memory access is made to the indicated physical address. This translation process is transparent to the application programs.

Each application program typically executes in its own virtual address space. To make each virtual address space appear relatively unlimited, the operating system makes use of a mass storage medium such as a hard disk, which is typically referred to as secondary storage or secondary memory to distinguish it from primary or physical memory. Secondary storage is usually relatively slow to access, but normally has a capacity much larger than that of primary memory. The operating system monitors memory usage and when portions of virtual memory are not being used, the data from the corresponding portions of physical memory is moved to secondary storage. Thus, at any given time, some portions of virtual memory will correspond to portions of physical memory, and some virtual memory will correspond to portions of secondary memory.

If an application program attempts to access a portion of virtual memory that is currently held in secondary storage, there will be no appropriate entry in the translation table. This is referred to as a “miss,” in response to which the operating system intervenes, loads the appropriate data back into physical memory and creates an appropriate translation entry in the translation table. After this is accomplished, the control is returned to the application program, which accesses the memory in its normal fashion.

The process of moving data between primary and secondary storage is referred to as memory “swapping” and normally takes place on an ongoing basis. As part of this process, the operating system maintains and updates its virtual-to-physical address mappings so that any reference to a virtual memory address will be translated to the appropriate physical address. The virtual-to-physical mappings change frequently in response to memory swapping.

Thus, in systems that support virtual memory, the operating system allocates virtual memory to requesting application programs. Prior to use, however, the operating system loads needed portions of the virtual memory into portions of physical memory, and provides address translations between virtual and physical memory addresses. In systems such as these, physical memory can be considered to be allocated whenever it is the target of an active virtual-to-physical memory mapping as described above. The operating system is configured to notify controller 14 when memory becomes allocated in this fashion.

Regardless of the method of physical memory allocation, the operating system is configured to identify allocated memory to memory controller 14 when physical memory is allocated for use. Similarly, the operating system is configured to instruct or notify memory controller 14 when physical memory is de-allocated and is no longer in use. Memory controller 14 responds by refreshing currently allocated memory, and by not refreshing memory that is not currently allocated. More specifically, either memory controller 14 or the memory device responds by setting or programming use registers 24, depending on whether the associated memory rows are being used. A use register 24 is set or programmed to a true value if the corresponding row is allocated and being used, and is set or programmed to a false value if the corresponding row is not allocated and not being used. Subsequently, the memory subsystem is responsive to the use registers 24 to refresh only those memory rows that are not unused.

In accordance with one implementation, memory controller 14 is configured to issue refresh operations at a rate such that every row gets refreshed once per TREF interval. In response to receiving a refresh instruction for a particular row, an individual DRAM checks the appropriate use register to determine whether the row is in use. If it is, the refresh operation proceeds as normal. If the row is not in use, the DRAM ignores the refresh instruction.

As an alternative, the memory controller could check the use registers before issuing a refresh instruction, and omit the refresh instruction if the current row is not in use. However, this would involve added communications between the memory controller and the memory devices, and would tend to impede normal bus communications.

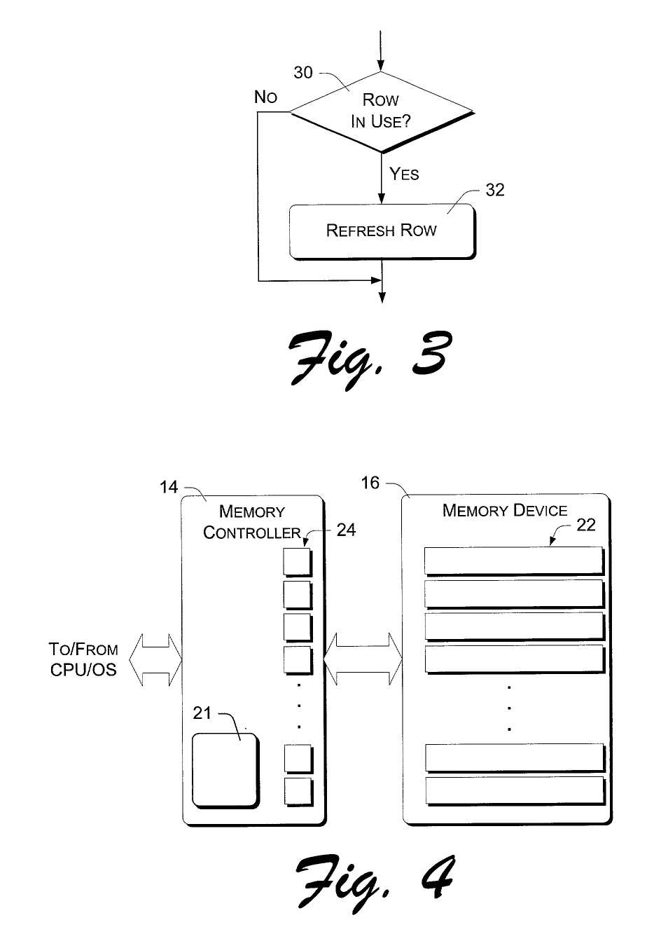

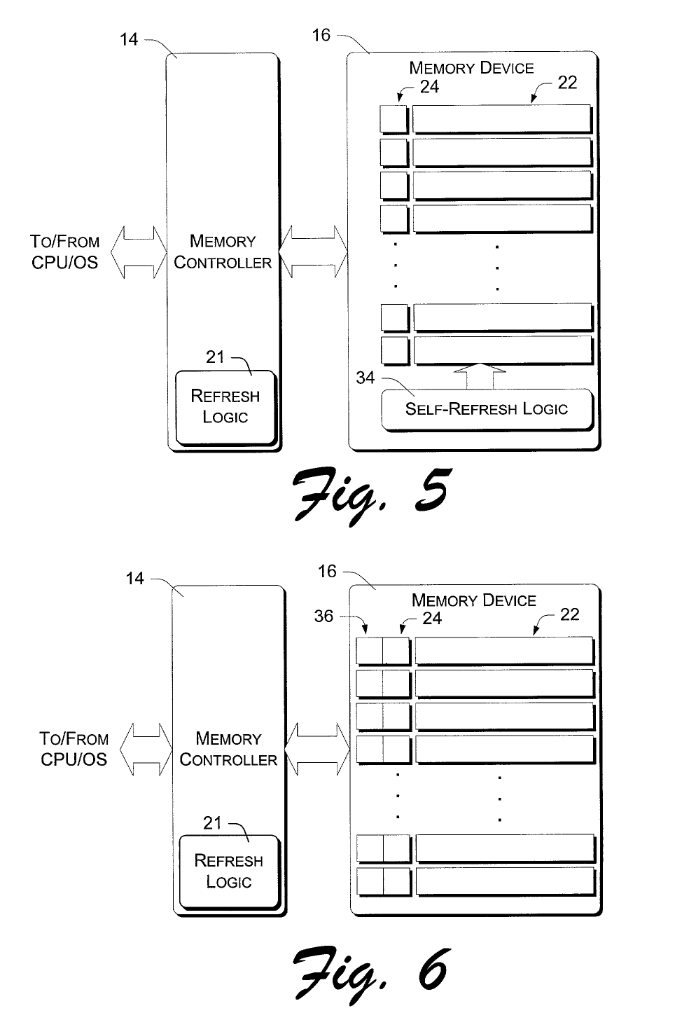

FIG. 3 shows actions performed with respect to each row of a memory device. These actions are initiated at least once for each memory row during every refresh period TREF. At the appropriate interval, the controller issues a refresh operation which may include the address of the row to be refreshed. If the refresh operation does not include an address, then the memory device automatically calculates the next address to be refreshed. The memory device checks the use register corresponding to the row to be refreshed. Prior to actually refreshing the row, as illustrated by block 30, the memory device accesses the appropriate use register 24 to determine whether the row is in use. If the row is in use, the memory device performs the refresh operation 32. If the row is not in use, the memory device skips block 32 and omits the refresh operation.

This configuration also works well in conjunction with systems utilizing broadcast refreshes. In systems such as this, the memory controller can send broadcast refresh requests to the memory devices, and the memory devices can ignore such requests for any unused rows, as determined by the use registers located on the individual memory devices.

Although the use registers or flags 24 are shown on individual memory devices for purposes of this example, the registers or flags could be physically located elsewhere. For example, they could be located on the memory controller, or on some other component other than the memory controller or memory device. FIG. 4 shows an implementation in which use registers or flags 24 are located on memory controller 14. If the use registers are located on the memory controller, the memory controller itself preferably determines whether to refresh individual rows. Specifically, the memory controller sends instructions only for those rows that are indicated to be in use, and omits refresh instructions for rows that are not in use.

FIG. 5 shows another implementation. In this implementation, it is advantageous to locate the use registers on the memory devices. Each memory device in this implementation includes self-refresh logic 34. Such self-refresh logic is typically utilized in reduced power modes of DRAM memory devices. In normal operation, refreshes are performed by memory controller 14. In reduced power modes, refreshes are performed by the self-refresh logic of the memory devices themselves.

Before a device enters self-refresh mode, use bits can be set whenever a read or write operation is performed to a row of the memory device. They can be cleared by explicit commands to the memory device, originated by the memory controller, operating system, or application, for example.

When a DRAM enters self-refresh, these bits can be checked to determine if a row needs to be refreshed or not. Specifically, self-refresh logic 34 is responsive to the use registers or flags 24 to determine whether to refresh individual rows. Self-refresh logic 34 refreshes a row if the corresponding use register indicates that the row is in use, and omits refreshing for any particular row if that row's use register indicates that the row is unused.

Although the use registers have been described and shown as corresponding to respective rows, they could alternatively correspond to sets of memory cells defined in some other way. For example, each use register or flag might correspond to a group of memory cells, a bank of memory cells, or a page of memory cells. In this case, a single use flag indicates whether or not the memory cells of a memory bank or page are in use. The flag is set to a true value if any cells of the bank or page are being used. During refreshing, all rows or cells of the bank or page are refreshed when the corresponding use register indicates that the bank or page is in use.

FIG. 6 shows yet another implementation. This implementation is similar to that of FIG. 2, in that use registers 24 are located on memory device 16. In addition, however, this implementation includes a plurality of “recent-access” registers or flags 36. Each such recent-access register 36 corresponds to a row of memory cells, and indicates whether the associated memory row was accessed, during the previous refresh cycle interval, in a manner that had the effect of refreshing the cells of the memory row. For example, in many types of DRAMs, a RAS or “activate” operation, although not explicitly comprising a refresh operation, has the same side-effects as a refresh operation with respect to the row upon which the RAS operation acts. Specifically, some types of memory operations other than explicit refresh operations have the effect of refreshing memory cells. In these types of DRAMs, if a RAS or activate operation is performed on a row, this can be tracked by the recent-access register corresponding to that row, indicating that a refresh operation is not needed for that row during the current interval.

Thus, each time a memory row is accessed in a manner that has the effect of a refresh operation (but is not an explicit refresh operation), that row's recent-access register is set—either by memory controller 14 or by memory device 16. This indicates that the row has been refreshed during the previous refresh period by some operation other than an explicit refresh operation. This allows refreshing of recently accessed memory rows to be omitted.

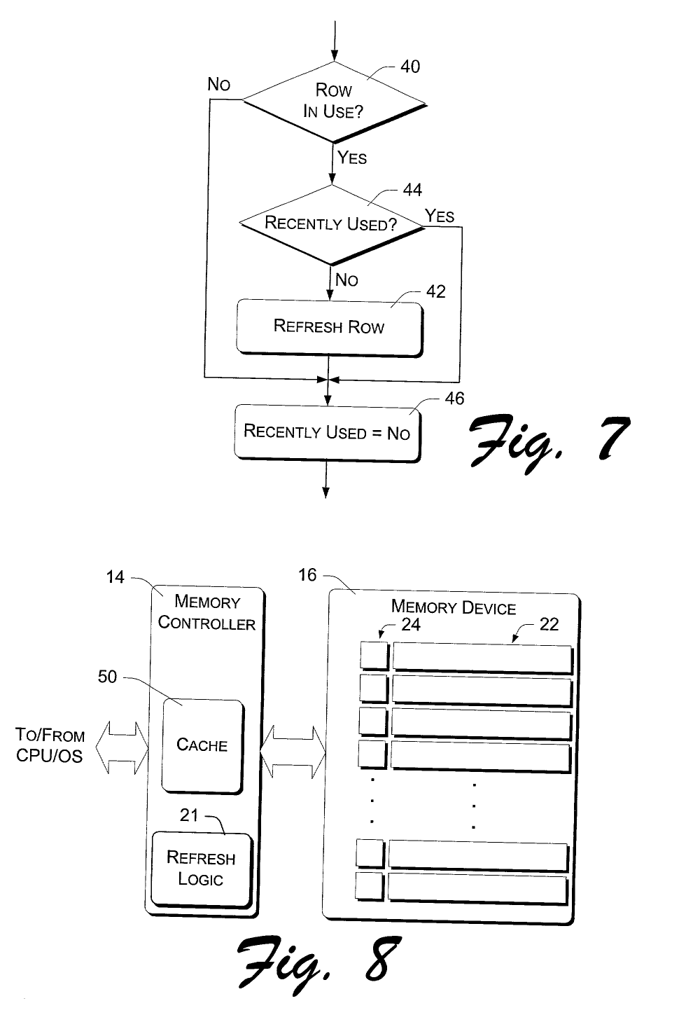

FIG. 7 shows refreshing actions performed by memory controller 14 with respect to each row of a memory device in accordance with the implementation shown by FIG. 6. These actions are initiated at least once for every memory row during every refresh period TREF. Prior to refreshing a row, as illustrated by block 40, memory controller 14 accesses the appropriate use register 24 to determine whether the row is in use. If the row is not in use, the subsequent refreshing operation 42 is skipped. If the row is in use, an operation 44 accesses the appropriate recent-access register 36 to determine whether the current row has already been refreshed during the previous refresh cycle interval. If the row has already been refreshed, refreshing operation 42 is skipped. Refreshing 42 is performed only if use register 24 is true and recent-access register 36 is false. As a concluding operation 46, recent-access register 36 is reset for the next refresh period.

Although the described implementation includes the recent-access registers as part of individual memory devices, they might alternatively be implemented elsewhere, such as on a memory controller. Furthermore, each recent-access register or flag might correspond to a set of memory cells other than a row, such as a group of memory cells, a bank of memory cells, or a page of memory cells.

An alternative embodiment might include the concept of recent-access registers, apart from use registers. In an embodiment such as this, the memory controller or memory device checks only whether a particular row has been recently refreshed before proceeding with the refresh operation. Although this embodiment allows refreshing of memory areas that may not be in actual use, it relieves the operation system of the burden of notifying the memory components about such memory usage.

FIG. 8 shows yet another implementation. This implementation is similar to that shown in FIG. 2, and the same reference numerals have therefore been used for similar or identical components. In this implementation, however, memory controller 14 includes a cache or buffer 50 that is used to cache individual memory rows of memory device 16. Specifically, memory controller 14 is configured to buffer or cache at least some of those memory rows whose use registers indicate they are in use. The refresh logic of memory controller 14 is configured to then operate the cached memory device rows in reduced power modes, such as by omitting refreshing for those rows that have been cached.

To omit refreshing for cached rows, the memory controller programs the use registers of the rows to indicate that the rows are no longer in use. Once a memory row is cached, subsequent accesses to cached memory are made directly to and from cache 50, instead of from the memory devices 16. When the memory row is no longer cached, and its contents are flushed back to the corresponding memory row, the corresponding use flag is reprogrammed to indicate that the row is again in use.

Although the techniques above have been described in relation to DRAM memory in which power saving are accomplished by omitting the refreshing rows of unused memory areas, the concept of tracking in-use memory areas can potentially be applied to other types of memory devices to reduce power consumption. For example, certain types of memory devices might have built-in reduced power modes, in which less power is consumed at the expense of greater access latency. By identifying unused portions of memory, it is possible to invoke such reduced power modes in an intelligent manner to lessen any detrimental effects of the reduced power modes. Specifically, it is possible to invoke such reduced power modes only for devices or portions of devices in which either no memory is currently in use or relatively little memory is in use.

Similarly, the caching concept introduced with reference to FIG. 8 can be used advantageously with memory devices having built-in reduced power modes. To take advantage of such reduced power modes, the memory controller first identifies targeted areas of memory based on usage. In conjunction with the techniques discussed above, the memory controller can identify these areas of memory based on whether their use flags are set. In other embodiments, the memory controller might monitor memory usage and identify areas of memory that are accessed most frequently.

After identifying targeted areas of memory that are in use or that are currently receiving high usage, the controller is configured to cache such areas in cache 50. The controller then identifies the memory devices containing the targeted memory or significant portions of the targeted memory, and sets those memory devices to reduced power modes.

In one embodiment, cache 50 is preferably large enough to cache the entire memory contents of one or more memory devices. In this embodiment, the memory controller identifies the memory device receiving the highest usage, and caches the entire contents of the identified memory device.

However, this technique is also applicable in systems where cache 50 is smaller. In systems where cache 50 is too small to cache an entire memory device, at least the most frequently accessed memory portions of the device are cached. Remaining portions are accessed in the reduced power mode at potentially slower access speeds. Because these remaining portions are less frequently used, however, the slower speeds will have minimal effect.

The techniques described above can be used in many systems to produce significant power savings. Furthermore, such power savings will often have few or no detrimental side-effects, because the power-saving measures are taken with respect to memory areas that are not actually being used. The described techniques therefore avoid the prior art tradeoff between access speed and power savings.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A memory device comprising:
a plurality of dynamically refreshable memory cells; and
one or more dynamically changeable use registers corresponding respectively to groups of one or more memory cells, wherein the use registers are configurable to indicate whether the corresponding groups of memory cells are in use;
wherein the memory device is configured to omit refreshing of memory cells that are not in use.

2. A memory device as recited in claim 1, further comprising self-refresh logic on the memory device, wherein the self-refresh logic is configured to not refresh the indicated unused memory cells.

3. A memory device as recited in claim 1, further comprising recent-access flags associated with respective sets of the memory cells, the recent-access flags being configured to indicate whether the associated sets of memory cells were accessed in a manner that refreshed the memory cells during a previous refresh cycle interval, wherein the memory device is configured to omit refreshing of those memory cells that are indicated by the recent-access flags to have been accessed in a manner that refreshed the memory cells during a previous refresh cycle interval.

4. A system comprising a plurality of memory devices as recited in claim 1, further comprising a memory controller configured to set the use registers to indicate whether the memory cells are unused.

5. A system comprising a plurality of memory devices as recited in claim 1, further comprising a memory controller configured to periodically refresh only those memory cells that are indicated by the use registers to be in use.

6. A system comprising a plurality of memory devices as recited in claim 1, further comprising a memory controller configured to cache at least some of those memory cells that are indicated by the use registers to be in use and to omit refreshing of the cached memory cells.

7. A memory device as recited in claim 1, wherein the use registers comprise bits that each correspond to a set of memory cells.

8. A memory device as recited in claim 1, wherein the use registers comprise bits that each correspond to a row of memory cells.

9. A memory device as recited in claim 1, wherein the use registers comprise bits that each correspond to a bank of memory cells.

10. A memory device as recited in claim 1, wherein the use registers comprise bits that each correspond to a page of memory cells.

11. A memory device comprising:
a plurality of memory cells; and
one or more dynamically changeable use registers corresponding respectively to groups of one or more memory cells, wherein the use registers are programmable to indicate whether the corresponding groups of memory cells are in use.

12. A memory device as recited in claim 11, further comprising self-refresh logic on the memory device, wherein the self-refresh logic is configured not to refresh unused memory cells.

13. A memory device as recited in claim 11, further comprising recent-access flags associated with respective sets of the memory cells, the recent-access flags being configured to indicate whether the associated sets of memory cells were accessed in a manner that refreshed the memory cells during a previous refresh cycle interval, wherein the memory device is configured to omit refreshing of those memory cells that are indicated by the recent-access flags to have been accessed in a manner that refreshed the memory cells during a previous refresh cycle interval.

14. A system comprising a plurality of memory devices as recited in claim 11, further comprising a memory controller configured to program the use registers depending on whether the memory cells are being used.

15. A system comprising a plurality of memory devices as recited in claim 11, further comprising a memory controller that is configured to refresh only those memory cells indicated by the use registers to be in use.

16. A system comprising a plurality of memory devices as recited in claim 11, further comprising a memory controller that is configured to operate unused memory cells at reduced power.

17. A system comprising a plurality of memory devices as recited in claim 11, further comprising a memory controller configured to cache at least some of those memory cells whose use registers indicate they are not unused and to omit refreshing of the cached memory cells.

18. A memory device as recited in claim 11, wherein the use registers comprise bits that each correspond to a row of memory cells.

19. A system comprising:
one or more memory devices having dynamically refreshable memory cells;
a memory controller configured to periodically refresh the memory cells of the memory devices;
one or more dynamically changeable use registers corresponding respectively to groups of one or more memory cells, wherein the use registers are configurable to indicate whether the corresponding groups of memory cells are in use; and
refresh logic configured not to refresh memory cells that are not in use.

20. A system as recited in claim 19, further comprising recent-access flags associated with the memory cells, the recent-access flags being configurable to indicate whether corresponding memory cells were accessed in a manner that refreshed the memory cells during a previous refresh cycle interval, wherein the memory controller is configured not to refresh those memory cells that are indicated to have been accessed in a manner that refreshed the memory cells during the previous refresh cycle interval.

21. A system as recited in claim 19, wherein the memory controller is configured to cache at least some of those memory cells that are not indicated by the one or more use registers to be unused and to omit refreshing of the cached memory cells.

22. A system as recited in claim 19, wherein the use registers are on the memory controller.

23. A system as recited in claim 19, wherein the use registers are on the memory devices.

24. A system as recited in claim 19, wherein the use registers comprise bits that each correspond to a row of memory cells.

25. A system comprising:
memory;
a memory controller;
an operating system configured to dynamically allocate and de-allocate the memory and to identify allocated and de-allocated memory to the memory controller;
wherein the memory controller is responsive to the operating system to operate non-allocated memory at reduced power.

26. A system as recited in claim 25, wherein the memory is dynamically refreshable memory and the memory controller operates the non-allocated memory at reduced power by omitting refreshing of non-allocated memory.

27. A system as recited in claim 25, further comprising recent-access flags associated with the memory, the recent-access flags being configurable to indicate whether corresponding memory cells were accessed in a manner that refreshed the memory cells during a previous refresh cycle interval, wherein the memory controller is configured not to refresh those memory cells that are indicated to have been accessed in a manner that refreshed the memory cells during the previous refresh cycle interval.

28. A system as recited in claim 25, wherein memory controller is configured to cache at least some of the allocated memory and to omit refreshing of the cached memory.

29. A system as recited in claim 25, further comprising a plurality of use bits corresponding respectively to memory rows, wherein each use bit being configurable to indicate whether its corresponding memory row is currently allocated, and wherein the memory controller is configured to omit refreshing of memory rows that are not currently allocated.

30. A system as recited in claim 25, further comprising a plurality of use bits on the memory controller corresponding respectively to memory rows, wherein each use bit is configurable to indicate whether its corresponding memory row is currently allocated, and wherein the memory controller is configured to omit refreshing of memory rows that are not currently allocated.

31. A system as recited in claim 25, wherein the memory comprises a plurality of discrete memory devices, the system further comprising a plurality of use bits on the memory devices corresponding respectively to memory rows, wherein each use bit is configurable to indicate whether its corresponding memory row is currently allocated, and wherein the memory controller configured to omit refreshing of memory rows that are not currently allocated.

32. In a system having dynamically refreshable memory rows, a method of memory power management, comprising:
keeping track of which memory rows are in use and therefore need refreshing;
periodically refreshing those memory rows that are in use; and
omitting refreshing of memory rows that are not in use.

33. A method as recited in claim 32, further comprising:
determining which rows have been accessed in a manner that refreshed the memory cells during a previous refresh cycle interval; and
omitting refreshing of memory rows that have been accessed in a manner that refreshed the memory cells during the previous refresh cycle.

34. A method as recited in claim 32, further comprising:
caching at least some of the memory rows that are in use; and
omitting refreshing of the cached memory rows.

35. A method as recited in claim 32, wherein keeping track comprises maintaining a plurality of flags corresponding respectively to the memory rows.

36. A memory controller configured to perform actions comprising:
receiving notifications regarding which of a plurality of memory cells are in use; and
operating unused portions of memory in reduced power modes.

37. A memory controller as recited in claim 36, wherein operating unused portions of memory at reduced power modes comprises omitting refreshing of unused memory rows.

38. A memory controller configured to perform actions comprising:
periodically refreshing memory cells;
receiving notifications regarding which memory cells are in use; and
omitting refreshing of those memory cells that are not in use.

39. A memory controller as recited in claim 38, the controller being configured to perform further actions comprising:
keeping track of which memory cells have been accessed in a manner that refreshed the memory cells during a previous refresh cycle interval; and
omitting refreshing of those memory cells that have been accessed in a manner that refreshed the memory cells during the previous refresh cycle.

40. A memory controller as recited in claim 38, the controller being configured to perform further actions comprising:
caching at least some of the memory cells that are in use; and
omitting refreshing of the cached memory cells.

41. An apparatus comprising:
one or more dynamically changeable use registers that are configurable to indicate unused memory cells;
refresh logic that is configured to periodically refresh memory cells that are not indicated to be unused.

42. An apparatus as recited in claim 41, wherein the use registers correspond respectively to sets of memory cells.

43. An apparatus as recited in claim 41, wherein the use registers correspond respectively to rows of memory cells.

44. An apparatus as recited in claim 41, wherein the use registers correspond respectively to banks of memory cells.

45. An apparatus as recited in claim 41, wherein the use registers correspond respectively to pages of memory cells.

46. A method comprising:
identifying areas of memory based on usage;
caching the identified areas of memory;
identifying one or more memory devices containing the identified areas of memory; and
setting said one or more identified memory devices to a reduced power mode.

47. A method as recited in claim 46, wherein:
said caching comprises caching all the memory cells of a particular memory device; and
said setting comprises setting said particular memory device to the reduced power mode.

48. A memory controller configured to perform actions comprising:
periodically refreshing memory;
identifying areas of memory based on usage;
caching the identified areas of memory;
operating the identified areas of memory in a reduced power mode.

49. A memory controller as recited in claim 48, wherein operating the identified areas of memory in a reduced power mode comprises omitting refreshing of the identified areas.

50. A memory controller as recited in claim 48, wherein operating the identified areas of memory in a reduced power mode comprises setting one or more memory devices to a reduced power mode.

51. A memory controller as recited in claim 48, wherein:
said caching comprises caching all the memory cells of a particular memory device; and
said setting comprises setting said particular memory device to the reduced power mode.

52. A method comprising:
periodically refreshing memory cells;
keeping track of which memory cells have been accessed in a manner that refreshed the memory cells during a previous refresh cycle interval; and
omitting refreshing of those memory cells that have been accessed in a manner that refreshed the memory cells during the previous refresh cycle.

53. A memory controller as recited in claim 52, further comprising:
receiving notifications regarding which memory cells are in use; and
omitting refreshing of those memory cells that are not in use.
